(19) United States
(12) Patent Application Publication
(10) Pub. No.: US 2017/0061358 A1
(43) Pub. Date: Mar. 2, 2017

(54) INTERESTED CANDIDATES

(71) Applicant: LinkedIn Corporation, Mountain View, CA (US)

(72) Inventors: Monica Marie Lewis, Menlo Park, CA (US); Prasad Kamalakar Gune, Fremont, CA (US); Qi Liu, Saratoga, CA (US); Matthew Spencer Rendely, San Francisco, CA (US)

(21) Appl. No.: 15/193,996

(22) Filed: Jun. 27, 2016

Related U.S. Application Data
(60) Provisional application No. 62/212,490, filed on Aug. 31, 2015.

(51) Int. Cl. G06Q 10/06; G06F 17/30; G06Q 10/10; H04L 29/08

(52) U.S. Cl. CPC G06Q 10/063112; H04L 67/306; G06F 17/30864; G06Q 10/1053; G06Q 50/01

(57) ABSTRACT

Techniques for facilitating a member of an online social networking service to indicate a future career intent are described. Data corresponding to a career intent action by a member of the social networking service is received by asocial networking service. The social networking service then transmits to the member data corresponding to a career intent questionnaire to be presented to the member, the career intent questionnaire including one or more questions regarding a career intent of the member. A career intent of the member is received by the social networking service as data corresponding to one or more answers provided by the member in response to the one or more questions. The social networking service then associates the received career intent of the member with the member's profile, stores the career intent, and exposes the career intent to a search for candidates corresponding to the career intent.

### CLAIM OF PRIORITY

This patent application claims the benefit of priority under 35 U.S.C. §119(e) to U.S. Provisional Patent Application Ser. No. 62/212,490, filed on Aug. 31, 2015, entitled, “INTERESTED CANDIDATES,” which is hereby incorporated by reference herein in its entirety.

### TECHNICAL FIELD

The present disclosure relates generally to online social networking services and specifically to facilitating a member of an online social networking service to indicate a future career intent.

### BACKGROUND

An online social networking service is a computer- or web-based application that enables users to establish links or connections with other people to share information with one another. Some online social networking services aim to enable friends and family to communicate and share information with one another, while others are specifically directed to business users with a goal of facilitating the establishment of professional relationships and the sharing of business information. As used herein, the terms “social network,” “social networking service,” “online social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

### BRIEF DESCRIPTION OF THE DRAWINGS

Some embodiments are illustrated by way of example and not limitation in the figures of the accompanying drawings.

FIG. 1 is a block diagram illustrating various components of an online social networking service with one or more career intent and interest applications, according to an embodiment.

FIG. 2 is an illustration of an example electronic profile of a member, as implemented by some online social networking services currently available.

FIG. 3 is an illustration of an example general questionnaire to gather general career interests and intents from an interested candidate, according to an embodiment.

FIG. 4 is an illustration of an example targeted questionnaire to gather from an interested candidate career interests and intents targeted for a particular industry, according to an embodiment.

FIG. 5 is an illustration of an example interested candidate search user interface used by recruiter members of social networking service to search for interested candidates by interested candidates' career interests and intents, according to an embodiment.

FIG. 6 is an illustration of an example view of electronic profile decorated with career intents and interests of an interested candidate, according to an embodiment.

FIG. 7 is a flow diagram illustrating a method performed by a social networking service that enables a member to associate future career interests and intents with the member's profile, according to an embodiment.

FIG. 8 is a block diagram illustrating an example of a machine, upon which any one or more example embodiments may be implemented.

### DETAILED DESCRIPTION

The present disclosure describes methods, systems, and computer program products that individually facilitate a member of an online social networking service to indicate a future career intent.

With some online social networks, members are prompted to provide a variety of information, which may be displayed on a member's web page on the online social network. Such information is commonly referred to as “personal profile information”, or simply “profile information”, and when shown collectively, it is commonly referred to as a “member profile.” With some online social networks, such as some business network services, a member's profile may include information commonly included in a professional resume or curriculum vitae, such as information about the member's education, employment history, job skills, job roles, job positions, professional organizations, and so forth. Each instance of this information on a member's profile may be referred to as a “feature” or a “facet.” A member's facets represent past and/or current information about the member.

Member profiles of online social networks provide a rich source of information about their members. Thus, employment recruiters are increasingly using online social networks to recruit candidates into open positions. A recruiter member of an online social network may find a candidate by searching or browsing member profiles that exhibit various desired facets. For example, a recruiter may search for members who have profiles indicating the possession of requisite skills and qualifications, such as certain technical skills, educational/professional experiences, backgrounds, etc.

Some online social networks, such as some business network services, allow employers members and/or recruiter members to post job postings to the online social network. Some online social networks match a member to one or more job postings based on the member's facets; conversely, some online social networks match a job posting to one or more members based on facets of the one or more members. As a member's facets represent past and/or current information regarding the member rather than intended or future information about the member, current online social networks are unable to match a member to job postings based on the member's intended or future career goals and, conversely, are unable to match a job posting to potential member candidates based on the member candidates' intended or future career goals. This deficiency leads to sub-optimal matching of jobs to members (and vice versa).

For example, a member of an online social network may have a member profile listing the member as living and/or working in geographical region A. However, the member wants or is willing to live and/or work in geographical region B. Because current online social networks do not have a mechanism to capture a geographical region where the member wants or is willing to live and/or work, the member's only recourse is to add that information in prose form to their member profile, for example in a “summary” section of the member profile (not shown). Although this may convey the geographical interest information to a person who reads the member's profile, the member's profile will not appear in a programmatic search of users. Thus, what is needed is a mechanism to allow member profiles to include future career intent and interest information in addition to past and present career information, and to allow searches within online social networks for candidates and/or jobs to use members' future career intent and interest information, Such mechanisms enable more accurate searches for candidates/jobs, more accurate matching of candidates to jobs, and enable recruiters to use the online social network to recruit candidates for “hard to fill” jobs (e.g., jobs that have very specific requirements).

In this document, the terms “interested candidate” and “candidate” describe a member of a social networking service who has indicated future career interests and intents.

There are at least two kinds of “indicators,” which indicate future career intent and interest information for a member: “explicit indicators” and “implicit indicators.” An “explicit indicator” is future career intent and interest information a member explicitly shares with others, whereas an “implicit indicator” is future career intent and interest information that a member allows to be included in searches (e.g., recruiter searches of member facets).

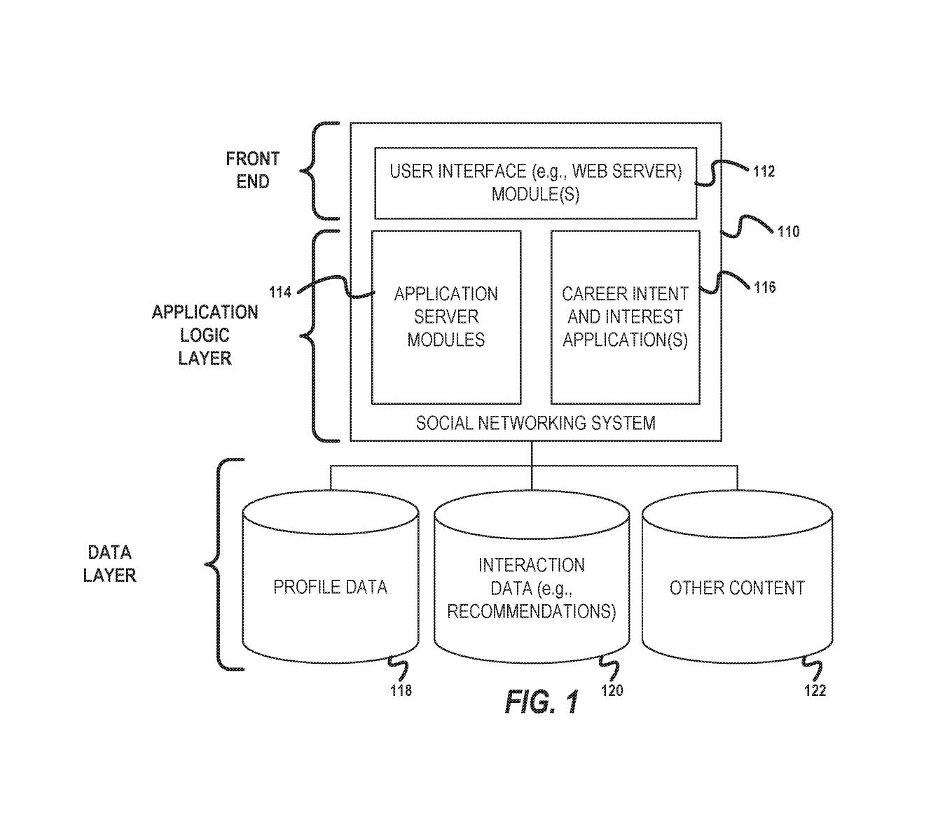

FIG. 1 is a block diagram illustrating various components of an online social networking service 110 with one or more career intent and interest applications 116, according to an embodiment. As shown in FIG. 1, the online social networking service 110 may be generally based on a three-tiered architecture, comprising a front-end layer, an application logic layer, and a data layer. As is understood by skilled artisans in the relevant computer and Internet-related arts, each module or engine shown in FIG. 1 may represent a set of executable software instructions and the corresponding hardware (e.g., memory and processor) for executing the instructions. To avoid obscuring the disclosure with unnecessary detail, various functional modules and engines that are not germane to conveying an understanding of the disclosed subject matter have been omitted from FIG. 1. However, a skilled artisan will readily recognize that various additional functional modules and engines may be used with an online social networking service 110 such as that illustrated in FIG. 1, to facilitate additional functionality that is not specifically described herein. Furthermore, the various functional modules and engines depicted in FIG. 1 may reside on a single server computer or may be distributed across several server computers in various arrangements.

As shown in FIG. 1, the front end may comprise a user interface module (e.g., a web server) 112, which may receive requests from various client computing devices (not shown), and may communicate appropriate responses to the requesting client computing devices. The user interface module(s) 112 may receive requests in the form of Hypertext Transport Protocol (HTTP) requests, or other web-based, application programming interface (API) requests. The application logic layer may include various application server modules 114, which, in conjunction with the user interface module(s) 112, may generate various user interfaces (e.g., web pages) with data retrieved from various data sources in the data layer. Individual application server modules 114 may be used to implement the functionality associated with various services and features of the online social networking service 110. Similarly, other applications or services that utilize the career intent and interest application(s) 116 may be embodied in their own application server modules 114.

As shown in FIG. 1, the data layer may include several databases, such as a database 118 for storing profile data (e.g., member profile data), database 120 for storing interaction data (e.g., employment referrals), and database 122 for storing other content (e.g., job listings, interest groups, companies, advertisements, events, news, discussions, tweets, questions and answers, etc.)

Members of a social networking service 110 may be people or organizations (e.g., corporations, partnerships, non-profit organizations, etc.) When an entity (e.g., a person, a corporation, etc.) initially registers to become a member of the online social networking service 110, the entity may be prompted to provide some information about the entity. If the entity is a person, the prompted information may include personal information, such as his or her name, age (e.g., birthdate), gender, interests, contact information, home town, address, the names of the member's spouse and/or family members, educational background (e.g., schools, majors, etc.), employment history, skills, professional organizations, and so on. If the entity is a corporation, the prompted information may include the corporation's industry/industries, number of employees employed by the corporation, a URI, to the corporation's website, news, messages, etc. This information may be stored, for example, in profile database 118.

Once registered, a member may invite other members, or be invited by other members, to connect via the online social networking service 110. A “connection” may require a bi-lateral agreement by the members, such that both members acknowledge the establishment of the connection. Similarly, a member may elect to “follow” another member. In contrast to establishing a “connection,” the concept of “following” another member typically is a unilateral operation, and may not require acknowledgement or approval by the member that is to be followed. When one member follows another, the member who is following may receive automatic notifications about various activities undertaken by the member being followed. Members may follow or connect with organization members in the same way as they do person members.

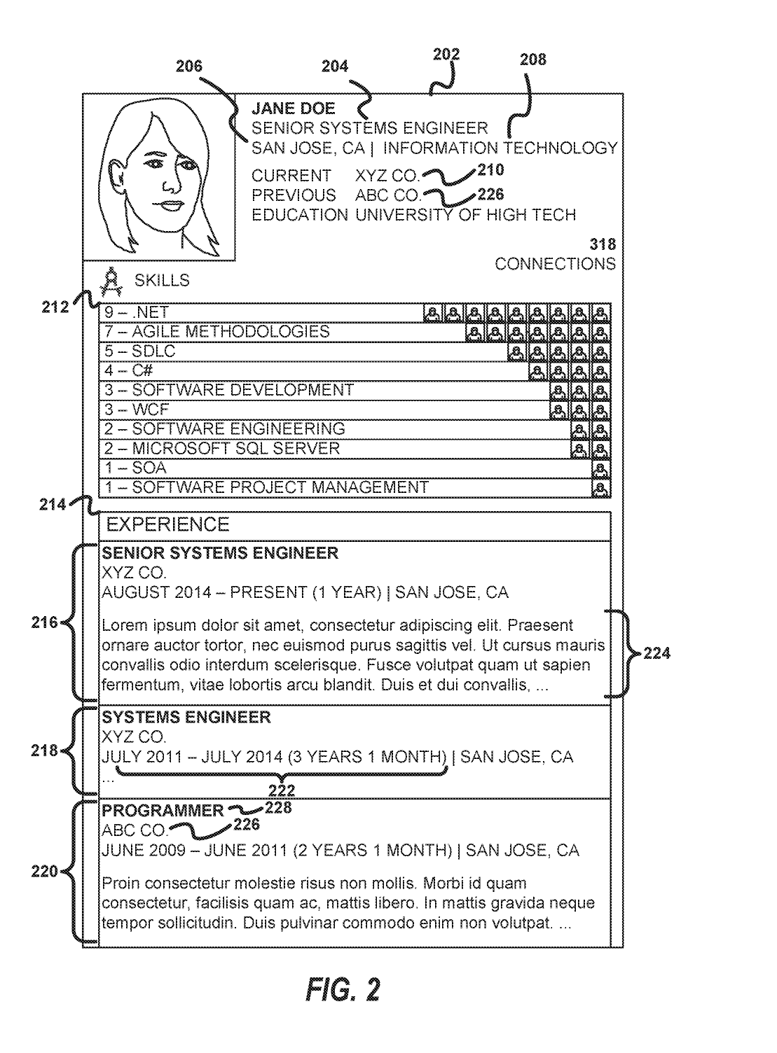

FIG. 2 is an illustration of an example electronic profile 202 of a member, as implemented by some online social networking services currently available. In addition to the member's name and picture, the example electronic profile 202 may include various information about the member. Such information may include a current job title 204, a geographical region 206 where the member works, an industry 208 in which the member works, a current employer 210 with whom the member is currently employed, a previous employer 226 with whom the member was most recently employed, etc. For example, the electronic profile 202 for member “Jane Doe” illustrated in FIG. 2 lists her current job title 204 as “Senior Systems Engineer,” “San Jose, Calif.” as a geographical region 206 where Jane works, “Information Technology” as an industry 208 in which Jane works, “XYZ Co,” as Jane's current employer 210, and “ABC Co.” as Jane's previous employer 226. The example electronic profile 202 may include a skills section 212 that lists the skills the member possesses.

The example electronic profile 202 may include an experience section 214 that describes the vocational, educational, and/or charitable experiences of the member. The experience section 214 may include one or more experience subsections; each experience subsection may describe a particular experience, such as a position held with an employer. Each experience subsection may include one or more of a job title the member held for that experience, the organization for that experience, a geographical region relevant to that experience, and a description 224 describing the experience. Each experience subsection may list a time period 222 for the experience, usually in the form of a start date, an end date, and the length of time from the start date through the end date. The experience section 214 may list the experience subsections in chronological order, reverse chronological order, etc.

For example, the experience section 214 of Jane Doe's example electronic profile 202 illustrated in FIG. 2 lists three experience subsections 216, 218, and 220. Experience subsection 216 describes Jane's current position as a Senior Systems Engineer at XYZ Co., experience subsection 218 describes Jane's previous position as a Systems Engineer at XYZ Co., and experience subsection 220 describes Jane's previous position as a Programmer at ABC Co.

Although example electronic profile 202 provides a significant amount of information about Jane, the information in example electronic profile 202 is limited to Jane's past and present information. By viewing only this example electronic profile 202, recruiters, potential employers, and others have no way to determine what Jane's future intents and interests are. Furthermore, Jane does not have an ability to add future intents and interests to her profile.

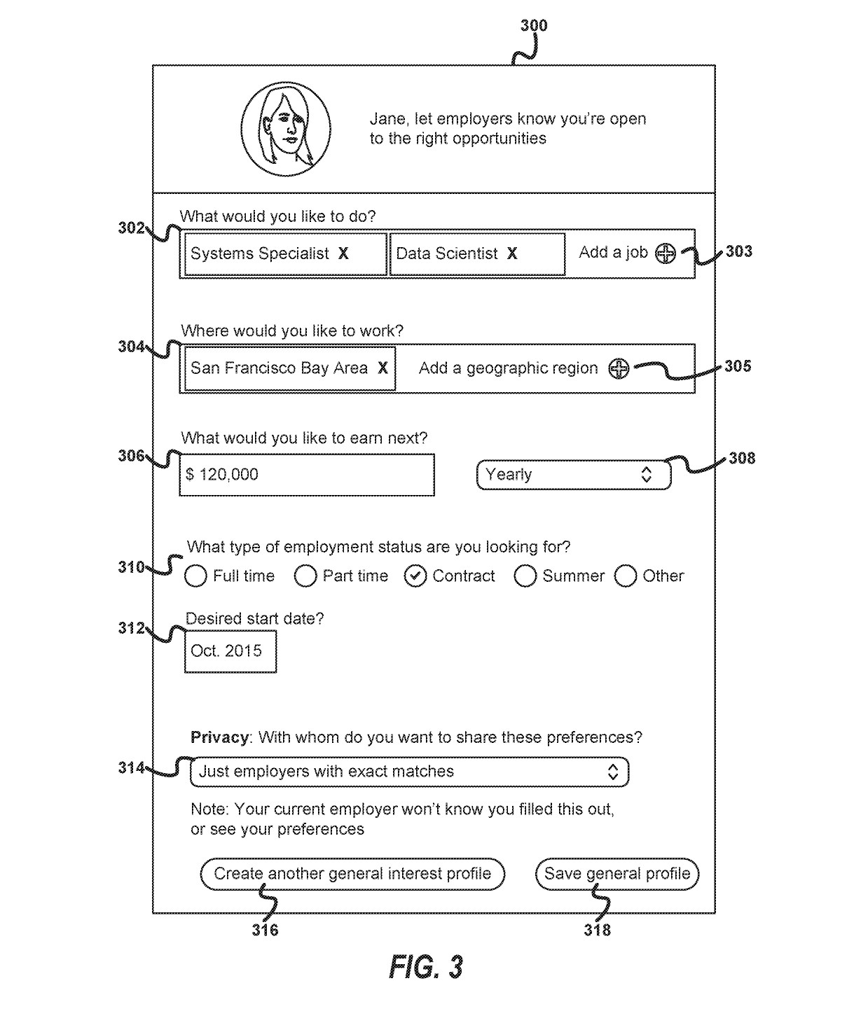

FIG. 3 is an illustration of an example general questionnaire 300 to gather general career interests and intents from an interested candidate, according to an embodiment. “General” career interests and intents are career interests and intents that are not specific to any particular job, industry, or employer. Examples of general career interests and intents may include one or more of: a title of a job in which the candidate is interested, a role/responsibility in which the candidate is interested in working, a geographical region in which the candidate is interested in working, a compensation which the candidate is interested in earning, the employment status of a job in which the candidate is interested in working, a desired start date for a new job, etc. The example general questionnaire 300 may include various input fields and selection controls to capture the candidate's general career interests and intents, and may save them as a “general career interests and intents profile”.

The social networking service 110 may present a general questionnaire, such as example general questionnaire 300, when a member performs an action on the social networking service 110 that indicates general career intent (“general career intent action”). A general career intent action may be any action performed by the member on the social networking service 110 that indicates a career intent that is not specific to a particular role or industry. Examples of general career intent actions may include one or more of: viewing a job posting on the social networking service 110, applying for a job via the social networking service 110, searching for a job using the social networking service 110, “following” an organization member on the social networking service 110, viewing an organization member's profile on the social networking service 110, etc. For example, a member searching for jobs in Los Angeles may be presented with a general questionnaire that asks the member, “Where specifically would you like to work in LA.?”

U.S. patent application Ser. No. 13/682,033, filed on Nov. 20, 2012 to Posse, et al. entitled, “TECHNIQUES FOR QUANTIFYING THE JOB-SEEKING PROPENSITY OF MEMBERS OF A SOCIAL NETWORK SERVICE,” which is incorporated herein by reference in its entirety, describes a job-seeking propensity algorithm that analyzes a variety of input data—including member profile data, social graph data, and activity or behavior data—to derive a job-seeker score, representing the job-seeking propensity of a member. Based on the job-seeker score, the member may be classified as an “active” job seeker, a “passive” job seeker, or a non-job-seeker. Presenting a general questionnaire when a member performs a career intent action on the social networking service 110 is particularly useful for gathering career interest and intent information from members classified as “passive job seekers” and “non-job seekers” because these members are less likely to enter this information without being prompted.

The example general questionnaire 300 may include a job title input field 302. By clicking on the add job control 303, a candidate is able to input into the job title input field 302 one or more job titles of jobs in which the candidate is interested in working. Clicking on the “X” of a job title present in the job title input field 302 removes that job title from the job title input field 302. The general questionnaire may include a “job role/responsibility” input field (not shown) instead of or in addition to the job title input field 302. As illustrated in FIG. 3, candidate “Jane Doe” has entered “Systems Specialist” and “Data Scientist” as job titles of jobs in which Jane Doe is interested in working.

The example general questionnaire 300 may include a geographical region input field 304. By clicking on the “add geographic region” control 305, a candidate is able to input into the geographical region input field 304 one or more geographical regions (e.g., continent, a country, a state, a county, a city, a neighborhood, etc) in which the candidate is interested in working. Clicking on the “X” of a geographic region present in the geographical region input field 304 removes that geographic region from the geographical region input field 304. As illustrated in FIG. 3, candidate “Jane Doe” has entered “San Francisco Bay Area” as a geographical region in which Jane Doe is interested in working.

The example general questionnaire 300 may include a compensation input field 306. A candidate is able to enter into the compensation input field 306 a compensation (e.g., salary) the candidate is interested in earning. The example general questionnaire 300 may also include a compensation period field 308, which allows a candidate to select a time period the candidate is interested in earning the compensation entered into compensation input field 306. The values available in compensation period field 308 may include, “yearly,” “quarterly,” “monthly,” “semi-monthly,” “bi -weekly,” “weekly,” “daily,” “hourly,” etc. As illustrated in FIG. 3, candidate “Jane Doe” has entered $120,000 into compensation input field 306 and has selected “Yearly” in compensation period field 308 as the time period for earning the entered compensation.

The general questionnaire may include one or more compensation fields, instead of or in addition to compensation input field 306 and compensation period field 308, to allow a candidate to enter more granular information regarding compensation. Examples include minimum compensation, minimum compensation to switch industries, minimum compensation to relocate to a selected geographical region, alternative compensation models (e.g., desired fringe benefits, desired stock options), etc.

The example general questionnaire 300 may include an employment status input control 310, which allows a candidate to enter or select an employment status, in which the candidate is interested. An employment status may be one or more of “full time,” “part time,” “contract,” “contract to hire,” “summer,” “school year,” “internship,” “externship,” “work for credit,” etc. As illustrated in FIG. 3, candidate “Jane Doe” has selected “contract” as an employment status in which Jane Doe is interested.

The example general questionnaire 300 may include a start date control 312, which allows a candidate to enter or select a desired start date for a potential new job. The “dates” entered into or selected within start date control 312 may vary in granularity. For example, the date may be as coarse as a year (e.g., “2017”) or a tine as a specific time on a specific day “8:00 A.M. on Monday, Apr. 3, 2017”.)

The example general questionnaire 300 may include a privacy preference control 314, which allows a candidate to select a privacy preference for the general career interests and intents profile that will be created with the answers to the questions within example general questionnaire 300. The values available in privacy preference control 314 may include one or more of:
Share with no one
Share only with designated members
Share only with employers that match designated criteria
Share with recruiters
Share with everyone
Share with everyone except designated members

The “share with no one” privacy preference may prevent sharing the general career interests and intents profile with anyone, but may allow the social networking service 110 to use the information in the general career interests and intents profile to provide information to the candidate (e.g., to suggest job postings, provide relevant employment data, etc.)

The “share only with designated members” privacy preference may allow the interested candidate to select the member(s), with whom the interested candidate is willing to share the general career interests and intents profile. For example, the designated members may include the interested candidate's mentors, previous co-workers, classmates, peers, etc. These members may seek or stumble upon opportunities that may align with the general career interests and intents profile of the interested candidate. Upon selecting the “share only with designated members” privacy preference, a member selection control (not shown) may be presented to the interested candidate; the member selection control may allow the interested candidate to select members with whom to share the career interests and intents profile.

The “share only with employers that match designated criteria” privacy preference may allow the interested candidate to specify criteria that determine those employer members, with whom the interested candidate is willing to share the general career interests and intents profile. Upon selecting the “share only with employers that match designated criteria” privacy preference, an employer criteria selection control (not shown) may be presented to the interested candidate. The employer criteria selection control may allow the interested candidate to specify the criteria to be used by the online social networking service 110 to determine those employer members with whom to share the career interests and intents profile. an employer member matches the specified criteria, the information within the associated career interests and intents profile of the interested candidate may be made available to searches performed by the employer member. For example, if an employer member, who matches the criteria specified by fictional member “Jane Doe” of FIG. 3, performs a search for candidates interested in working as a Business Analyst in the San Francisco Bay Area, Jane Doe's general career interests and intents profile will appear in the employer member's search results.

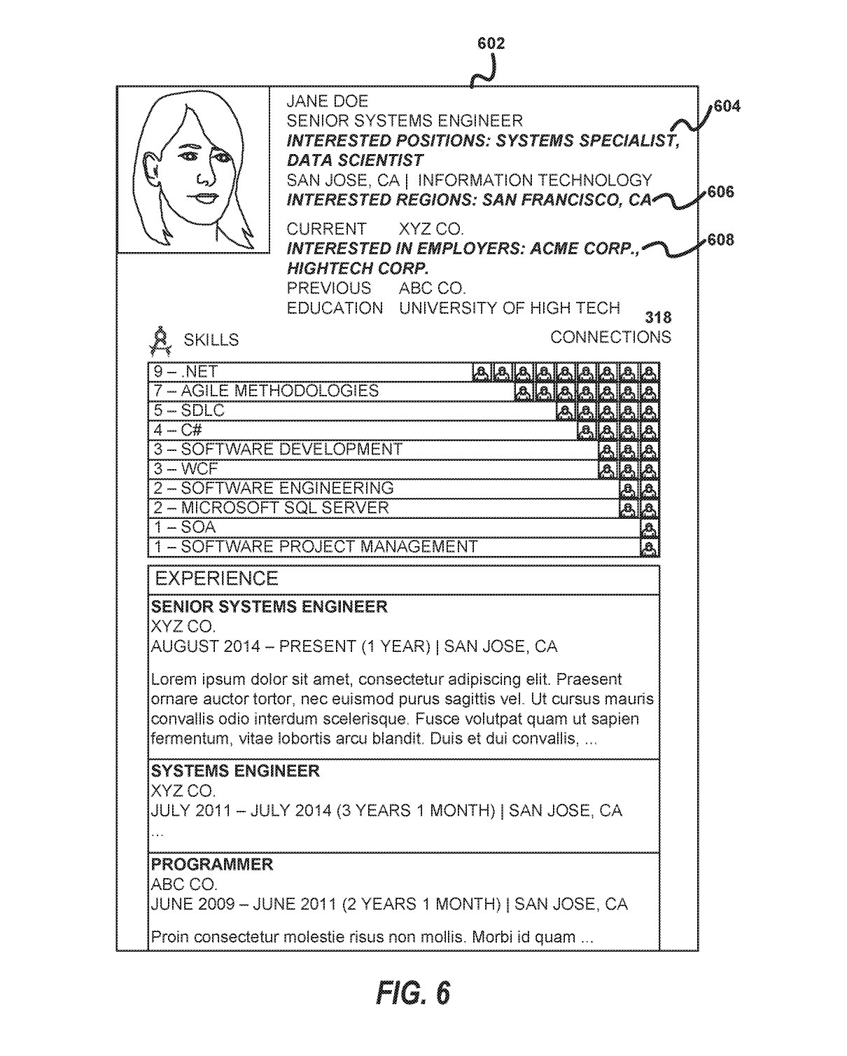

If an employer member matches the specified criteria and views the interested candidate's member profile, the information within the associated career interests and intents profile may be displayed on the interested candidate's member profile. For example, if an employer member, who matches the criteria specified in FIG. 3 by fictional member “Jane Doe,” views Jane's member profile, Jane's member profile may appear to the viewing employer member as decorated with the information within Jane's general career interests and intents profile (as illustrated in FIG. 6), rather than Jane's “regular” member profile (as illustrated in FIG. 2).

The designated criteria may include one or more of a variety of different facets of employers. For example, designated criteria may include employer size (in terms of number of employees), stock market capitalization of employer, employer industry, geographical presence of employer, recent/previous hiring by employer for a specific role, etc.

The “share with all recruiters” privacy preference may allow all recruiter members access to the information in the interested candidate's general career interests and intents profile. One effect of this privacy preference is that all recruiters may effectively know that the interested candidate is job seeking. A benefit of this privacy preference is that a recruiter that is recruiting for a related, but not identical, role indicated by the interested candidate may still find the interested candidate in a search, and therefore might contact the interested candidate.

The “share with everyone” privacy preference may allow all members who have access to the interested candidate's regular profile to access the information in the interested candidate's general career interests and intents profile.

The “share with everyone except designated members” privacy preference may allow the interested candidate to select the member(s), with whom the interested candidate is NOT willing to share the general career interests and intents profile; all other members may have access to the information in the interested candidate's general career interests and intents profile. For example, the designated members selected to be excluded from sharing may include the interested candidate's current employer, current co-workers, etc. The interested candidate might not want the designated members to know that the interested candidate is searching for a new job. Upon selecting the “share with everyone except designated members” privacy preference, a member selection control (not shown) may be presented to the interested candidate; the member selection control may allow the interested candidate to select members with whom NOT to share the interested candidate's associated career interests and intents profile.

The example general questionnaire 300 may include a control, such as the “save general profile” button 318, which may allow an interested candidate to save the values in the other controls of the example general questionnaire 300 as a general career interests and intents profile and closes the example general questionnaire 300.

The example general questionnaire 300 may include a control, such as the “create another general interest profile” button 316, which may allow an interested candidate to save the values in the other controls of the example general questionnaire 300 as a general career interests and intents profile. The control may then present to the interested candidate a new or reset example general questionnaire 300 to create another general career interests and intents profile. Under some circumstances, a candidate may want to create multiple general career interests and intents profiles. For example, an interested candidate is searching for a new job in the candidate's current field, but is also contemplating a career change into a different field. This candidate might not want potential employers in the candidate's current field to know that the candidate is also contemplating changing fields.

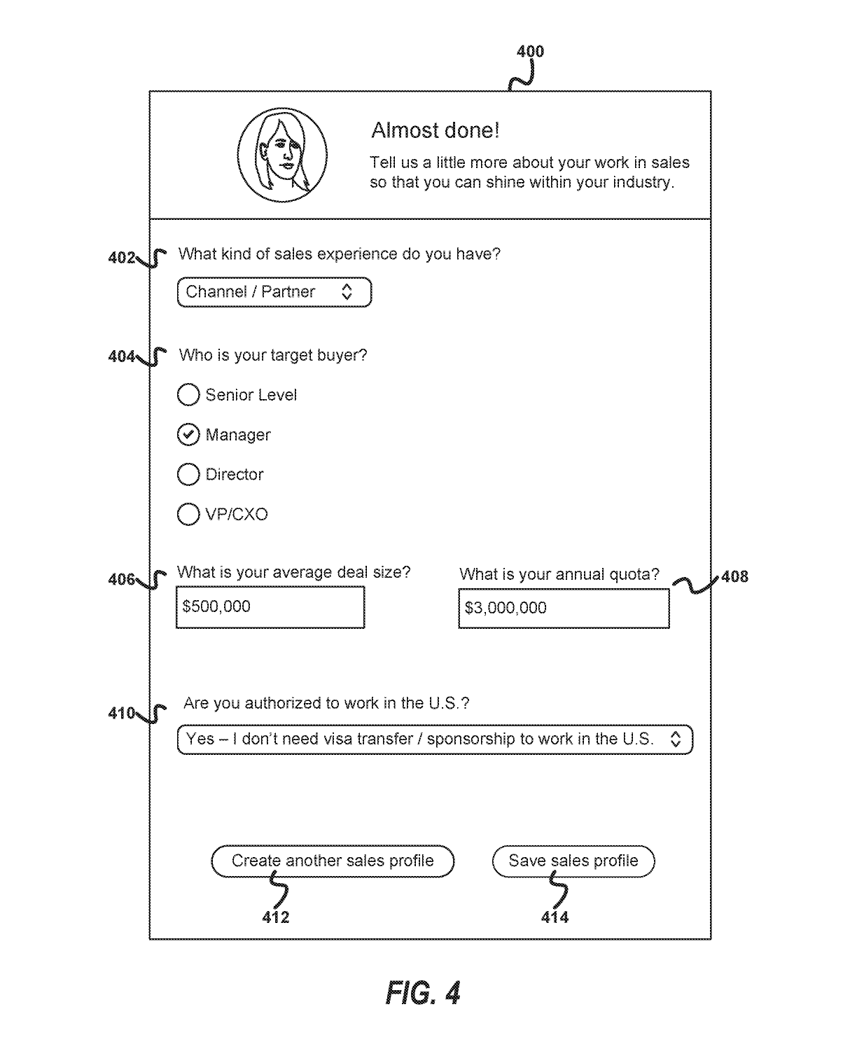

FIG. 4 is an illustration of an example targeted questionnaire 400 to gather from an interested candidate career interests and intents targeted for a particular industry, according to an embodiment. “Targeted” or “role-specific” career interests and intents are those that are specific or targeted to a particular job, industry, or employer. Example targeted questionnaire 400, as illustrated in FIG. 4, is targeted for the sales industry. Examples of targeted career interests and intents for the sales industry may include one or more of the type of sales experience of the interested candidate, the target buyers of the interested candidate, the interested candidate's average deal size, the interested candidate's annual quota, etc. Other industries, job roles/responsibilities, etc. may have their own specific questions.

The social networking service 110 may present a targeted questionnaire, such as example targeted questionnaire 400, when a member performs an action on the social networking service 110 that indicates specific career intent (“specific career intent action”). Examples of specific career intent actions may include one or more of: adding a specific skill to the member's profile, adding a specific employment industry to the member's profile, adding a current or previous employer to the member's profile, searching for a specific type of job using the social networking service 110, viewing a specific type of job posting on the social networking service 110, applying for a specific type of job via the social networking service 110, viewing a specific organization member's profile on the social networking service 110, “following” a specific organization member on the social networking service 110, etc.

The example targeted questionnaire 400 may include various input fields and selection controls to capture the interested candidate's career interests and intents for the sales industry and save them as a “specific career interests and intents profile”. As illustrated in FIG. 4, the example targeted questionnaire 400 includes input fields and selection controls to capture the type of sales experience of the interested candidate (control 402), the target buyers of the interested candidate (control 404), the interested candidate's average deal size (control 406), the interested candidate's annual quota (control 408), and the interested candidate's U.S. work status (control 410). The example targeted questionnaire 400 also includes a privacy preference control (not shown), similar to the privacy preference control 314 of example general questionnaire 300 illustrated in FIG. 3. A targeted questionnaire may also include other questions, such as desired telecommuting options, desired workplace dress code, a minimum compensation for which the member would switch jobs, etc.

The example targeted questionnaire 400 may include a control, such as the “save (targeted) profile” button 418, which may allow an interested candidate to save the values in the other controls of the example targeted questionnaire 400 as a targeted career interests and intents profile and may close the example targeted questionnaire 400. As illustrated in FIG. 4, the text of “save (targeted) profile” button 418 appears in example targeted questionnaire 400 as “save sales profile” because the example targeted questionnaire 400 is targeted to the sales field/profession.

The example targeted questionnaire 400 may include a control, such as the “create another (targeted) interest profile” button 416, which may allow an interested candidate to save the values in the other controls of the targeted questionnaire 400 as a targeted career interests and intents profile and may allow the candidate to create another targeted career interests and intents profile using anew or a reset example targeted questionnaire 400 presented to the interested candidate. Under some circumstances, a candidate may want to create multiple targeted career interests and intents profiles. For example, an interested candidate working in field X is searching for a new job in the candidate's current subfield X1, but is also contemplating switching jobs into a different subfield (X2) of field X. This candidate may not want potential employers in the candidate's current subfield (X1) to know that the candidate is also contemplating switching into a different subfield (X2).

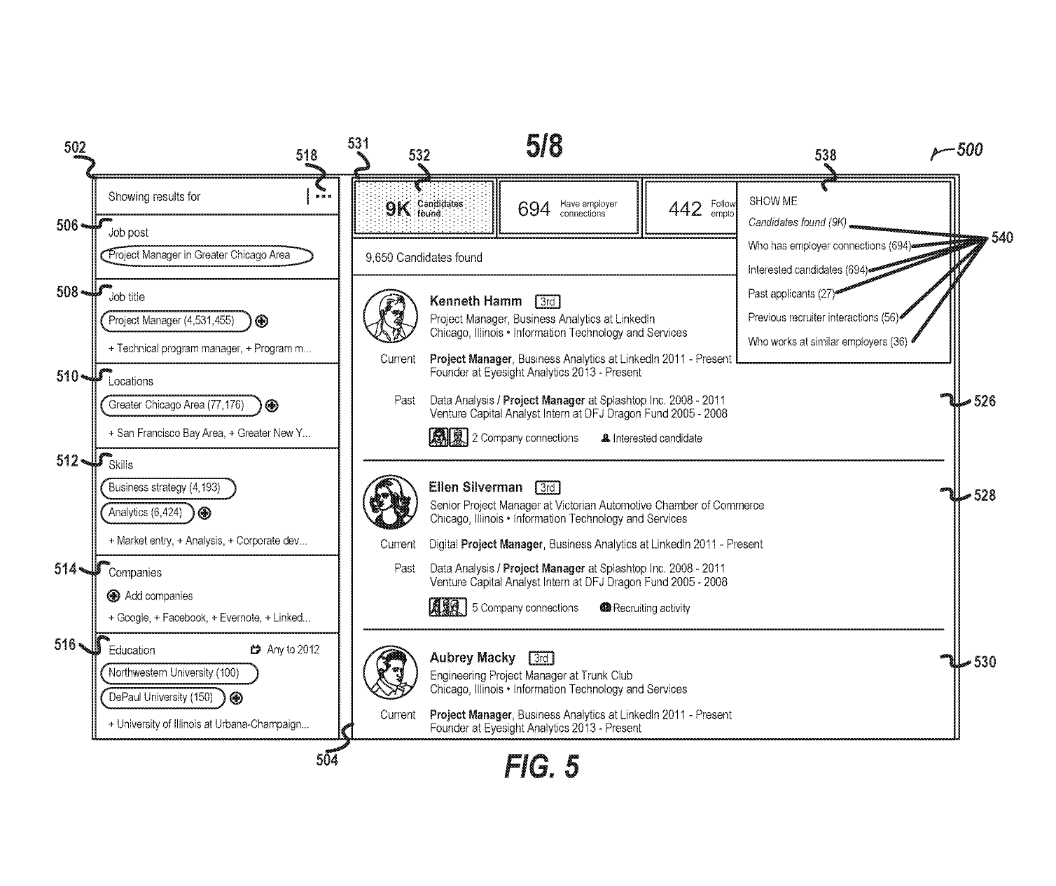

FIG. 5 is an illustration of an example interested candidate search user interface 500 used by recruiter members of social networking service 110 to search for interested candidates by interested candidates' career interests and intents, according to an embodiment. A search panel 502 may include various controls 506-524 to allow a recruiter member to select career interest and intent criteria as well as past and present facet criteria to search for candidates for a job. The results of the search may be displayed in search results panel 504.

The search panel 502 may include controls 506-524 for including general career interests and intents in the search for interested candidates. For example, job post control 506 may allow the recruiter to select the job posting(s) for which the recruiter is searching for interested candidates, job title control 508 may allow the recruiter to select the job title(s) of jobs in which interested candidates are interested, the job location control 510 may allow the recruiter to select the job location(s) of jobs in which interested candidates are interested, etc. Selecting the advanced search control 518 may open an advanced search interface (not shown) The search panel 502 may also allow the recruiter member to select targeted career interests and intents to be included in a search for interested candidates. By performing such searches, the social networking service 110 may provide the searching recruiter with an indication of candidates who have specified that they are actually interested in the specified criteria, rather than simply those candidates who have specified that they previously and/or currently match the specified criteria.

The search results panel 504 may display to a searching recruiter search results as member profiles for those candidates that have a career interests and intents profile that both 1) meets the search criteria used in the search panel 502 and 2) has a privacy preference that allows the recruiting member to view the interested candidate's career interests and intents profile. The search results panel 504 may have a vertical scrollbar (not shown) and/or a horizontal scrollbar (not shown) to allow the recruiter to scroll to view results that do not fit into the area of the search results panel 504. The member profiles displayed in the search results panel 504 may be abbreviated or partial member profiles. For example, the member profiles 526, 528, and 530 illustrated in FIG. 5 are abbreviated profiles. The recruiter may be able to select a displayed member profile to see additional information about the member and/or to contact the member.

The search results panel 504 may include a search results “dashboard” 531, which includes one or more search results filter controls. Each search results filter control has a “filter type;” when a search results filter control is selected, the search results are filtered according to the search results filter control's filter type. A filter type may be one or more of: candidates found (e.g., displays all candidates found), have company connections (e.g., displays those candidates that have at least one connection to either the employer of the job posting or an employee of the employer of the job posting), interested candidates (e.g., displays those candidates that have a career interests and intents profile), past applicants (e.g., displays those candidates that have previously applied for this job posting), previous recruiter interactions (e.g., displays those candidates that have had previous interactions with this recruiter), works at a similar company (e.g., displays those candidates that work at an employer similar to the employer of the job posting), etc. As illustrated in FIG. 5, the “candidates found” search results filter control 532 is shaded, indicating that this control has been selected; thus, all 9,650 candidates matching the criteria specified in the search panel 502 are displayed in the search results panel 504. In sonic embodiments, more than one search results filter control may be selected; if more than one search results filter control is selected, the search results may be filtered to include either the union or the intersection of the selected search results filter controls.

The search results “dashboard” 531 may include a “show me” control 538, which includes one or more search results filter controls as selectable text controls 540; selecting a text control 540 has the same effect as selecting the corresponding search results filter control.

Upon a recruiter submitting to social networking service 110 a job posting for an open job, social networking service 110 may provide the recruiter with interested candidates that meet criteria set by the recruiter for that job posting.

FIG. 6. is an illustration of an example view of an electronic profile 602 decorated with career intents and interests of an interested candidate, according to an embodiment. When viewed by a member that meets the privacy preference specified for a respective career interest and intent profile of the interested candidate, the interested candidate's electronic profile 602 may appear to the viewing member as decorated with information from the interested candidate's respective career interest and intent profile.

As illustrated in FIG. 6, Jane Doe's electronic profile 602 is decorated with information gathered from Jane using the example general questionnaire 300 from FIG. 3. For example, the job titles Jane entered into job title input field 302 of the example general questionnaire 300 appear on Jane's decorated electronic profile 602 as interested positions 604, the geographical region Jane entered into geographical region input field 304 appears on Jane's decorated electronic profile 602 as interested regions 606, etc.

The employers in which Jane indicated she is interested also appear on Jane's electronic profile 602. This information may be part of another of Jane's career interests and intents profiles, which the viewing member is qualified to view, Depending upon how many career interests and intents profiles associated with an interested candidate and depending upon the respective privacy preference for each respective career interests and intents profile associated with the interested candidate, different viewing members may see different versions of the interested candidate's member profile 602. Thus, the decorated versions of interested candidate's member profile 602 may range from 1) completely undecorated (such as the example member profile 202 illustrated in FIG. 2), which would appear to a member without access to any of the interested candidate's career interests and intents profiles, to 2) decorated with all information from every career interests and intents profile associated with the interested candidate.

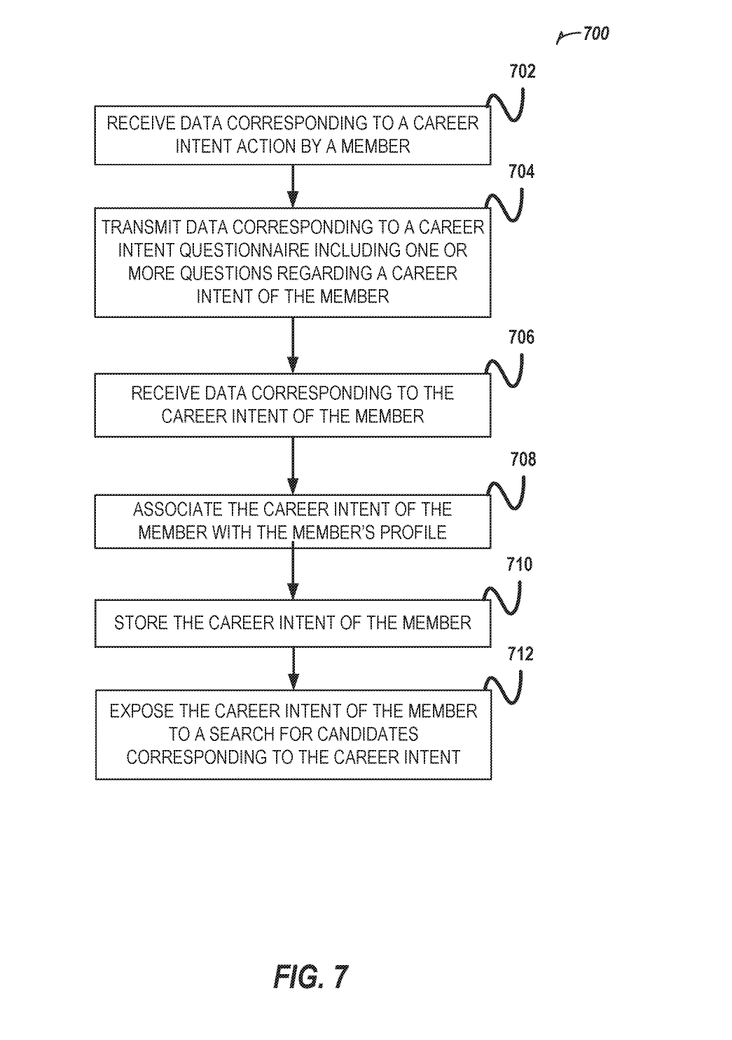

FIG. 7 is a flow diagram illustrating a method 700 performed by a social networking service 110 that enables a member to associate future career interests and intents with the member's profile, according to an embodiment.

Data corresponding to a career intent action by a member on the social networking service 110 is received by the social networking service 110 (operation 702). The career intent action may be a general career intent action (as described in the paragraphs accompanying FIG. 3) or a specific career intent action (as described in the paragraphs accompanying FIG. 4).

Data corresponding to a career intent questionnaire, such as example general questionnaire 300 or example targeted questionnaire 400, is transmitted by the social networking service 110 (operation 704). The data may be transmitted to a computing device operated by the member, and the computing device may present the career intent questionnaire to the member.

Data corresponding to a career intent of the member is received by the social networking service 110 (operation 706).

The received data corresponding to the career intent of the member is associated with the member's profile by the social networking service 110 (operation 708).

The received data corresponding to the career intent of the member is stored by the social networking service 110 (operation 710).

The career intent of the member is exposed by the social networking service 110 to searches for jobs based on the member's career intent (operation 712). The career intent of the member may also be exposed to searches for candidates based on career intent.

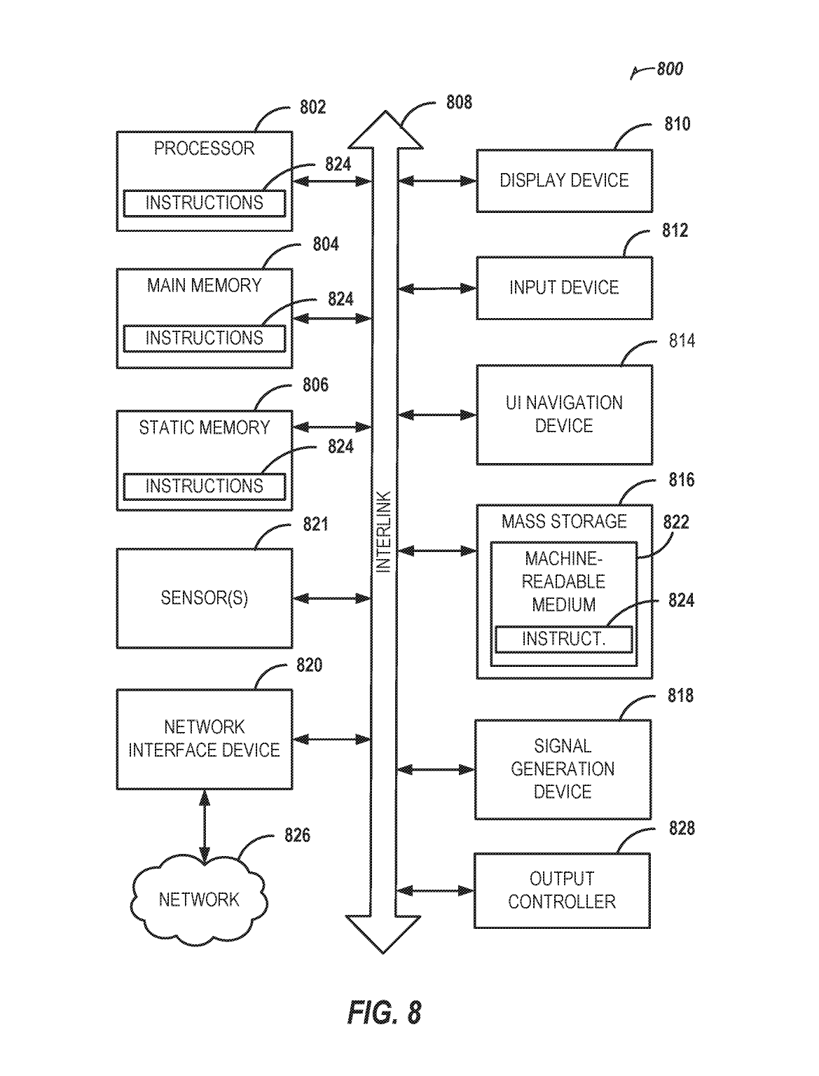

FIG. 8 is a block diagram illustrating an example of a machine 800, upon which any one or more example embodiments may be implemented. In alternative embodiments, the machine 800 may operate as a standalone device or may be connected (e.g., networked) to other machines. In a networked deployment, the machine 800 may operate in the capacity of a server machine, a client machine, or both in a client-server network environment. In an example, the machine 800 may act as a peer machine in a peer-to-peer (P2P) (or other distributed) network environment. The machine 800 may implement or include any portion of the systems, devices, or methods illustrated in FIGS. 1-7, and may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, although only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations, etc.

Examples, as described herein, may include, or may operate by, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 821, such as a global positioning system (GPS) sensor, compass, accelerometer, or other sensor. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.)

The storage device 816 may include a machine-readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine-readable media.

Although the machine-readable medium 822 is illustrated as a single medium, the term “machine-readable medium” may include a single medium or multiple media (e.g., a centralized or distributed database, and/or associated caches and servers) configured to store the one or more instructions 824.

The term “machine-readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices, magnetic disks, such as internal hard disks and removable disks; magneto-optical disks; Random Access Memory (RAM); Solid State Drives (SSD); and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as WiFi®, IEEE 802.16 family of standards known as WiMAX®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### Additional Notes & Example Embodiments

Example 1 is a method performed by an online social network, the method comprising: receiving data corresponding to a career intent action by a member of the online social network; transmitting, to a computing device operated by the member, data corresponding to a career intent questionnaire to be presented to the member, the career intent questionnaire including one or more questions regarding a career intent of the member; receiving, from the computing device, the career intent of the member as data corresponding to one or more answers provided by the member in response to the one or more questions; associating the career intent of the member with the member's profile; storing the career intent of the member; and exposing the career intent of the member to a search for candidates corresponding to the career intent.

In Example 2, the subject matter of Example 1 optionally includes searching for a set of job postings accessible within the online social network, each job posting in the set corresponding to the career intent of the member; and transmitting, to the computing device operated by the member, the set of job postings to be presented to the member.

In Example 3, the subject matter of any one or more of Examples 1-2 optionally include wherein the career intent action is at least one of: viewing a job posting on the online social network, applying to a job represented by a posting on the online social network, searching for a job posting on the online social network, viewing an employer profile on the online social network, or selecting to receive updates from an employer on the online social network.

In Example 4, the subject matter of any one or more of Examples 1-3 optionally include wherein the career intent is one of: a general career intent and a role-specific career intent.

In Example 5, the subject matter of Example 4 optionally includes wherein a general career intent is at least one of: desired job title, desired geographical region, desired compensation, desired industry, and desired job responsibility.

In Example 6, the subject matter of any one or more of Examples 1-5 optionally include receiving, by the online social network, a privacy setting for the career intent.

In Example 7, the subject matter of Example 6 optionally includes wherein the privacy setting for the career intent is at least one of: share with no one, share only with designated members, share only with employers that match designated criteria, share with recruiters, share with everyone, or share with everyone except designated members.

In Example 8, the subject matter of Example 7 optionally includes decorating the member profile with the career intent; and presenting, to a user of the online social network, the decorated member profile upon the privacy setting for the career intent allowing the user to view the career intent.

Example 9 is at least one machine-readable medium including instructions, which when executed by a machine, cause the machine to perform operations of any of the methods of Examples 1-8.

Example 10 is an apparatus comprising means for performing any of the methods of Examples 1-8.

Example 11 is at least one machine-readable medium including instructions which, when executed by a machine; cause the machine to: receive data corresponding to a career intent action by a member of the online social network; transmit, to a computing device operated by the member, data corresponding to a career intent questionnaire to be presented to the member, the career intent questionnaire including one or more questions regarding a career intent of the member; receive, from the computing device, the career intent of the member as data corresponding to one or more answers provided by the member in response to the one or more questions; associate the career intent of the member with the member's profile; store the career intent of the member; and expose the career intent of the member to a search for candidates corresponding to the career intent.

In Example 12, the subject matter of Example 11 optionally includes wherein the instructions further cause the machine to: search for a set of job postings accessible within the online social network, each job posting in the set corresponding to the career intent of the member; and transmit, to the computing device operated by the member, the set of job postings to be presented to the member.

In Example 13, the subject matter of any one or more of Examples 11-12 optionally include wherein the career intent action is at least one of: viewing a job posting on the online social network, applying to a job represented by a posting on the online social network, searching for a job posting on the online social network, viewing an employer profile on the online social network, or selecting to receive updates from an employer on the online social network.

In Example 14, the subject matter of any one or more of Examples 11-13 optionally include wherein the career intent is one of: a general career intent and a role-specific career intent.

In Example 15, the subject matter of Example 14 optionally includes wherein a general career intent is at least one of: desired job title, desired geographical region, desired compensation, desired industry, and desired job responsibility.

In Example 16, the subject matter of any one or more of Examples 11-15 optionally include wherein the instructions further cause the machine to: receive, by the online social network, a privacy setting for the career intent.

In Example 17, the subject matter of Example 16 optionally includes wherein the privacy setting for the career intent is at least one of: share with no one, share only with designated members, share only with employers that match designated criteria, share with recruiters, share with everyone, or share with everyone except designated members.

In Example 18, the subject matter of Example 17 optionally includes wherein the instructions further cause the machine to: decorate the member profile with the career intent; and present, to a user of the online social network, the decorated member profile upon the privacy setting for the career intent set to allow the user to view the career intent.

Example 19 is an online social network, comprising: at least one machine-readable medium including instructions which, when executed by an online social network, cause the online social network to: receive data corresponding to a career intent action by a member of the online social network; transmit, to a computing device operated by the member, data corresponding to a career intent questionnaire to be presented to the member, the career intent questionnaire including one or more questions regarding a career intent of the member; receive, from the computing device, the career intent of the member as data corresponding to one or more answers provided by the member in response to the one or more questions; associate the career intent of the member with the member's profile; store the career intent of the member; and expose the career intent of the member to a search for candidates corresponding to the career intent.

In Example 20, the subject matter of Example 19 optionally includes wherein the instructions further cause the online social network to: search for a set of job postings accessible within the online social network, each job posting in the set corresponding to the career intent of the member; and transmit, to the computing device operated by the member, the set of j ob postings to be presented to the member.

In Example 21, the subject matter of any one or more of Examples 19-20 optionally include wherein the career intent action is at least one of: viewing a job posting on the online social network, applying to a job represented by a posting on the online social network, searching for a job posting on the online social network, viewing an employer profile on the online social network, or selecting to receive updates from an employer on the online social network.

In Example 22, the subject matter of any one or more of Examples 19-21 optionally include wherein the career intent is one of: a general career intent and a role-specific career intent.

In Example 23, the subject matter of Example 22 optionally includes wherein a general career intent is at least one of: desired job title, desired geographical region, desired compensation, desired industry, and desired job responsibility.

In Example 24, the subject matter of any one or more of Examples 19-23 optionally include wherein the instructions further cause the online social network to: receive, by the online social network, a privacy setting for the career intent.

In Example 25, the subject matter of Example 24 optionally includes wherein the privacy setting for the career intent is at least one of: share with no one, share only with designated members, share only with employers that match designated criteria, share with recruiters, share with everyone, or share with everyone except designated members.

In Example 26, the subject matter of Example 25 optionally includes wherein the instructions further cause the online social network to: decorate the member profile with the career intent; and present, to a user of the online social network, the decorated member profile upon the privacy setting for the career intent set to allow the user to view the career intent.

Conventional terms in the fields of computer networking and computer systems have been used herein. The terms are known in the art and are provided only as a non-limiting example for convenience purposes. Accordingly, the interpretation of the corresponding terms in the claims, unless stated otherwise, is not limited to any particular definition.

Although specific embodiments have been illustrated and described herein, it will be appreciated by those of ordinary skill in the art that any arrangement that is calculated to achieve the same purpose may be substituted for the specific embodiments shown. Many adaptations will be apparent to those of ordinary skill in the art. Accordingly, this application is intended to cover any adaptations or variations.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. Moreover, in the following claims, the terms “first,” “second,” and “third,” etc. are used merely as labels, and are not intended to impose numerical requirements on their objects.

In this Detailed Description, various features may have been grouped together to streamline the disclosure. This should not be interpreted as intending that an unclaimed disclosed feature is essential to any claim. Rather, inventive subject matter may lie in less than all features of a particular disclosed embodiment Thus, the following claims are hereby incorporated into the Detailed Description, with each claim standing on its own as a separate embodiment, and it is contemplated that such embodiments may be combined with each other in various combinations or permutations. The scope of the embodiments should be determined with reference to the appended claims, along with the full scope of equivalents to which such claims are entitled.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to allow the reader to quickly ascertain the nature of the technical disclosure and is submitted with the understanding that it will not be used to interpret or limit the scope or meaning of the claims.

What is claimed is:

1. A method performed by an online social network, the method comprising:
receiving data corresponding to a career intent action by a member of the online social network;
transmitting, to a computing device operated by the member, data corresponding to a career intent questionnaire to be presented to the member, the career intent questionnaire including one or more questions regarding a career intent of the member;
receiving, from the computing device, the career intent of the member as data corresponding to one or more answers provided by the member in response to the one or more questions;
associating the career intent of the member with the member's profile;
storing the career intent of the member; and
exposing the career intent of the member to a search for candidates corresponding to the career intent.

2. The method of claim 1, further comprising:
searching for a set of job postings accessible within the online social network, each job posting in the set corresponding to the career intent of the member; and
transmitting, to the computing device operated by member, the set of job postings to be presented to the member.

3. The method of claim 1, wherein the career intent action is at least one of:
viewing a job posting on the online social network, applying to a job represented by a posting on the online social network, searching for a job posting on the online social network, viewing an employer profile on the online social network, or selecting to receive updates from an employer on the online social network.

4. The method of claim 1, wherein the career intent is one of: a general career intent and a role-specific career intent.

5. The method of claim 4, wherein a general career intent is at least one of:
desired job title, desired geographical region, desired compensation, desired industry, and desired job responsibility.

6. The method of claim 1, further comprising:
receiving, by the online social network, a privacy setting for the career intent.

7. The method of claim 6, wherein the privacy setting for the career intent is at least one of:
share with no one, share only with designated members, share only with employers that match designated criteria, share with recruiters, share with everyone, or share with everyone except designated members.

8. The method of claim 7, further comprising:
decorating the member profile with the career intent; and
presenting, to a user of the online social network, the decorated member profile upon the privacy setting for the career intent allowing the user to view the career intent.

9. At least one machine-readable medium including instructions which, when executed by a machine, cause the machine to:
receive data corresponding to a career intent action by a member of the online social network;
transmit, to a computing device operated by the member, data corresponding to a career intent questionnaire to be presented to the member, the career intent questionnaire including one or more questions regarding a career intent of the member;
receive, from the computing device, the career intent of the member as data corresponding to one or more answers provided by the member in response to the one or more questions;
associate the career intent of the member with the member's profile;
store the career intent of the member; and
expose the career intent of the member to a search for candidates corresponding to the career intent.

10. The at least one machine-readable medium of claim 9, wherein the instructions further cause the machine to:
search for a set of job postings accessible within the online social network, each job posting in the set corresponding to the career intent of the member; and
transmit, to the computing device operated by the member, the set of job postings to be presented to the member.

11. The at least one machine-readable medium of claim 9, wherein the career intent action is at least one of: viewing a job posting on the online social network, applying to a job represented by a posting on the online social network, searching for a job posting on the online social network, viewing an employer profile on the online social network, or selecting to receive updates from an employer on the online social network.

12. The at least one machine-readable medium of claim 9, wherein the career intent is one of: a general career intent and a role-specific career intent.

13. The at least one machine-readable medium of claim 12, wherein a general career intent is at least one of: desired job title, desired geographical region, desired compensation, desired industry, and desired job responsibility.

14. The at least one machine-readable medium of claim 9, wherein the instructions further cause the machine to:
receive, by the online social network, a privacy setting for the career intent.

15. The at least one machine-readable medium of claim 14, wherein the privacy setting for the career intent is at least one of:
share with no one, share only with designated members, share only with employers that match designated criteria, share with recruiters, share with everyone, or share with everyone except designated members.

16. The at least one machine-readable medium of claim 15, wherein the instructions further cause the machine to:
decorate the member profile with the career intent; and
present, to a user of the online social network, the decorated member profile upon the privacy setting for the career intent set to allow the user to view the career intent.

17. An online social network, comprising:
at least one machine-readable medium including instructions which, when executed by an online social network, cause the online social network to:
receive data corresponding to a career intent action by a member of the online social network;
transmit, to a computing device operated by the member, data corresponding to a career intent questionnaire to be presented to the member, the career intent questionnaire including one or more questions regarding a career intent of the member;
receive, from the computing device, the career intent of the member as data corresponding to one or more answers provided by the member in response to the one or more questions;
associate the career intent of the member with the member's profile;
store the career intent of the member; and
expose the career intent of the member to a search for candidates corresponding to the career intent.

18. The online social network of claim 17, instructions further cause the online social network to:
search for a set of j ob postings accessible within the online social network, each job posting in the set corresponding to the career intent of the member; and
transmit, to the computing device operated by the member, the set of job postings to be presented to the member.

19. The online social network of claim 17, wherein the career intent action is at least one of: viewing a job posting on the online social network, applying to a job represented by a posting on the online social network, searching for a job posting on the online social network, viewing an employer profile on the online social network, or selecting to receive updates from an employer on the online social network.

20. The online social network of claim 17, wherein the career intent is one of: a general career intent and a role-specific career intent.
